(19) United States
(12) Patent Application Publication
(10) Pub. No.: US 2022/0305731 A1
(43) Pub. Date: Sep. 29, 2022

(54) SYSTEMS AND METHODS FOR SURFACE TEXTURING OBJECTS DURING ADDITIVE MANUFACTURING

(71) Applicant: Carbon, Inc., Redwood City, CA (US)

(72) Inventor: Alexander D. Denmark, Redwood City, CA (US)

(21) Appl. No.: 17/655,865

(22) Filed: Mar. 22, 2022

Related U.S. Application Data
(60) Provisional application No. 63/167,195, filed on Mar. 29, 2021.

(51) Int. Cl. B29C 64/282; B29C 64/35; B29C 64/393

(52) U.S. Cl. CPC B29C 64/282; B29C 64/35; B29C 64/393; B33Y 10/00

(57) ABSTRACT

Surface texturing of objects during additive manufacturing, including systems and methods thereof. For example, a method of surface texturing a three-dimensional (3D) object during additive manufacturing of the object: (a) irradiating a resin segment with patterned light at a build plane to polymerize said resin and grow said 3D object, then (b) advancing said object away from said build plane to bring a new segment of said resin in contact with said growing 3D object and establish a new build plane, and then repeating steps (a) through (b) until said 3D object is formed. For resin segments that correspond to portions of said 3D object to which surface texture is applied, said irradiating step is carried out by sequentially irradiating each resin segment with: (i) a first sub-exposure pattern and (ii) a second sub-exposure pattern, one of which is modified to include a texture pattern on a surface thereof.

### RELATED APPLICATIONS

This application claims priority from U.S. Provisional Patent Application No. 63/167,195, filed Mar. 29, 2021, the disclosure of which is hereby incorporated by reference in its entirety.

This disclosure concerns additive manufacturing, such as bottom-up or top-down stereolithography, and particularly concerns systems and methods for applying surface texture to objects for additive manufacturing.

### BACKGROUND

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top down” techniques, where light is projected onto the resin on top of the growing object, which is then immersed downward into the pool of resin.

The recent introduction of a more rapid stereolithography technique known as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and U.S. Pat. No. 9,216,546 to DeSimone et al.; and also in J. Tumbleston, D. Shirvanyants, N. Ermoshkin et al., Continuous liquid interface production of 3D Objects, Science 347, 1349-1352 (2015); see also Rolland et al., U.S. Pat. Nos. 9,676,963, 9,453,142 and 9,598,606).

It is often desired to apply a surface texture to objects during additive manufacturing. A typical technique for doing so is given in FIG. 1. Starting from a virtual representation such as an STL file (11) in a computer of an object to be additively manufactured (or “printed”) the object is optionally displayed on a build platform on which it will be produced (12). The operator then selects (in any sequence) a type or style of surface texture to be applied (13), and a surface to which the texture is to be applied (14) (i.e., all of the object, or a selected portion of the object. A modified virtual representation (again such as an STL file) is then generated, which file is then converted into a sequence of exposure patterns or “slices” (17) by any of a variety of slicer programs (16). The exposure patterns (which in some cases are in the form of a PNG stack) are then sent to the 3D printer for production of the textured 3D object (18) in accordance with known techniques.

While the system set forth in FIG. 1 is satisfactory for some purposes, it has limitations. Adding a surface texture can change the dimension of the part, and surfaces that require precise tolerances cannot be textured. Many textures do not adequately mask channel lines, pixilation, smokiness, or other artifacts of the printing process. And, because this approach can require the filling of numerous surface mesh units with the texture, this system can be computationally intensive, slow, and/or result in poor resolution of the surface texture. Accordingly, there is a need for new techniques for surface texturing objects for additive manufacturing.

### SUMMARY

We have found that a visible pattern can be generated on the surface of an additively manufactured object by selectively inactivating surface pixels during additive manufacture of the object, in a patterned manner, during a portion of the time resin is exposed to those pixels. Since all surface pixels still receive some illumination, bulk polymerization of the object is substantially unchanged, yet a visible surface pattern is still imparted to the object.

Without wishing to be bound to any particular theory of the invention, the pattern may be created by localized differences in surface tension of the corresponding resin during curing thereof, and/or subtle local differences in shrinkage of the resin during curing thereof.

Numerous different patterns can be produced in this manner, and the phenomenon is sufficiently robust that it is observed not only with conventional, single cure, resins, but is seen in more advanced dual cure resins as well.

Aspects provide a method of surface texturing a three-dimensional (3D) object during additive manufacturing of the object from a polymerizable resin on a 3D printer, the 3D object having a shape defined by a primary set of exposure patterns, the method comprising the steps of: (a) irradiating a resin segment with patterned light at a build plane while said segment is contacting said growing 3D object to polymerize said resin and further grow said 3D object, then (b) advancing said object away from said build plane to bring a new segment of said resin in contact with said growing 3D object and establish a new build plane, and then (c) repeating steps (a) through (b) until said 3D object is formed. For those resin segments corresponding to portions of said 3D object to which surface texture is applied, said irradiating step is carried out by sequentially irradiating each resin segment with: (i) a first sub-exposure pattern comprising a member of the primary set of exposure patterns modified to include a texture pattern for a surface thereof; and (ii) a second sub-exposure pattern corresponding to said member of the primary set of exposure patterns.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 is a flow chart illustrating a prior art surface texturing system and method.

FIG. 2 is a flow chart illustrating a surface texturing system and method as described herein.

FIG. 3 schematically illustrates a sequence from input of an object, from which a primary set of exposure patterns is generated, then from which a modified set of exposure patterns is generated, and then from which a printed object can be produced, in accordance with a system and method as described herein.

FIG. 4A schematically illustrates a first sub-exposure pattern, where the surface of the object being produced is completely in-plane with the build platform, and hence every pixel would be a “surface pixel.” Selected surface pixels are inactivated during this exposure pattern.

FIG. 4B an alternate first sub-exposure pattern, where surface pixels that are on the sides of the object (e.g., surfaces of the object that neither contact a build platform nor a window) are patterned (selected pixels inactivated).

FIG. 4C illustrates a second sub-exposure pattern, for either first sub-exposure patterns of FIGS. 4A-4B, where all pixels are activated. This exposure pattern corresponds to the primary exposure pattern. Note, in both cases, bulk exposure of the object remains the same.

FIG. 4D schematically illustrates a portion of FIG. 4B (delineated by box 4D therein), and distinguishes surface pixels from underlying pixels. The underlying pixels are shown two rows deep. The cross-hatched boxes represent pixels that are selectively inactivated.

FIG. 5 is a graph schematically illustrating platform movement over time, and exposure over time, for a portion of a method as described in FIG. 3 herein, as it can be implemented in a bottom-up stereolithography apparatus. The solid line indicates the apparatus is operating in stepped mode, and the dashed line indicates the apparatus is operating in reciprocal (or “pumped”) mode. Note the sequential illumination of the resin by patterns 5^{a} and 5^{b} while the platform is stationary. Hence the same segment of resin is being exposed by both patterns.

FIG. 6 shows three sample objects additively manufactured from a dual cure resin (Carbon, Inc. RPU70), following washing and further curing, as textured during additive manufacturing with a diamond (D), checker (C), or XY grid strip (XY) texture pattern.

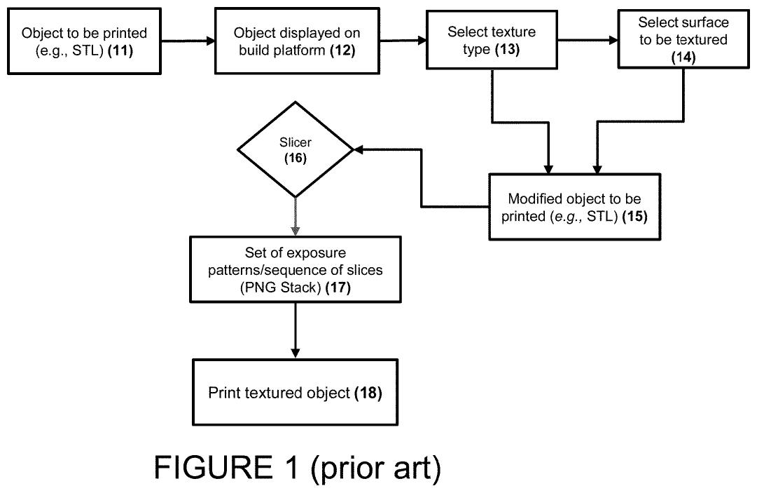

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

The disclosures of all United States patent references cited herein are incorporated herein by reference in their entirety.

As used herein, the term “and/or” includes any and all possible combinations of one or more of the associated listed items, as well as the lack of combinations when interpreted in the alternative (“or”).

### 1. General Systems and Methods.

Suitable additive manufacturing methods and apparatus, that can be modified as described herein for carrying out the methods described herein, include bottom-up and top-down additive versions thereof (generally known as stereolithography) are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of all identified patents and applications herein are incorporated by reference herein in their entirety.

In some embodiments, the additive manufacturing step is carried out by one of the family of methods sometimes referred to as continuous liquid interface production (CLIP), again modified as described herein. CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., US Patent Application Pub. No. US 2017/0129169 (May 11, 2017); Sun and Lichkus, US Patent Application Pub. No. US 2016/0288376 (Oct. 6, 2016); Willis et al., US Patent Application Pub. No. US 2015/0360419 (Dec. 17, 2015); Lin et al., US Patent Application Pub. No. US 2015/0331402 (Nov. 19, 2015); D. Castanon, S Patent Application Pub. No. US 2017/0129167 (May 11, 2017). B. Feller, US Pat App. Pub. No. US 2018/0243976 (published Aug. 30, 2018); M. Panzer and J. Tumbleston, US Pat App Pub. No. US 2018/0126630 (published May 10, 2018); K. Willis and B. Adzima, US Pat App Pub. No. US 2018/0290374 (Oct. 11, 2018) L. Robeson et al., PCT Patent Pub. No. WO 2015/164234 (see also U.S. Pat. Nos. 10,259,171 and 10,434,706); and C. Mirkin et al., PCT Patent Pub. No. WO 2017/210298 (see also US Pat. App. US 2019/0160733).

Dual cure resins. While any suitable resin can be used (including but not limited to those set forth in U.S. Pat. Nos. 9,211,678 and 9,216,546), in some embodiments, dual cure resins are preferred. Such resins are known and described in, for example, U.S. Pat. Nos. 9,676,963, 9,453,142 and 9,598,606 to Rolland et al. Particular examples of suitable dual cure resins include, but are not limited to, Carbon Inc. medical polyurethane, elastomeric polyurethane, rigid polyurethane, flexible polyurethane, cyanate ester, epoxy, and silicone dual cure resins, all available from Carbon, Inc., 1089 Mills Way, Redwood City, Calif. 94063 USA.

### 2. Surface Texturing Systems and Methods.

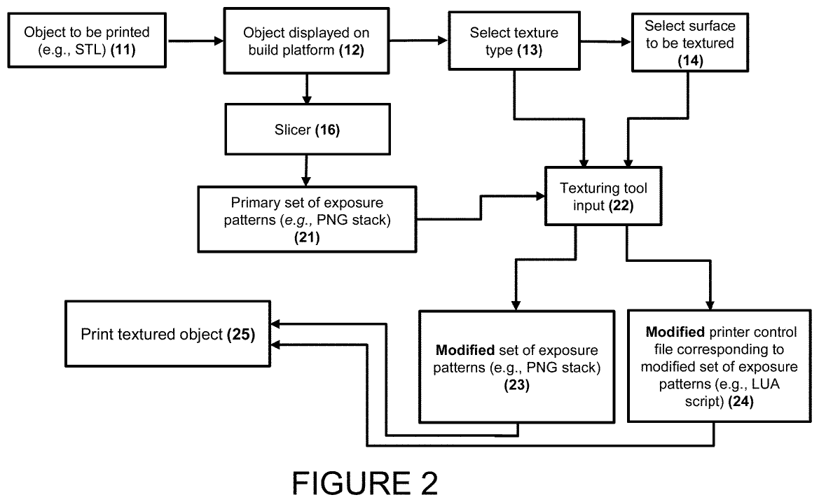

FIG. 2 is a flow chart illustrating a surface texturing system and method as described herein. Some embodiments of the present disclosure provide methods (e.g., computer-implemented methods) of applying a surface texture to a surface of a three-dimensional (3D) object during an additive manufacturing thereof. The 3D object may be manufactured from a resin on a 3D printer. Examples of such 3D printers include those offered by Carbon, Inc., 1089 Mills Way, Redwood City, Calif. 94063 USA.

During an additive manufacturing process, adjacent segments of the resin are sequentially light polymerized to form the 3D object. Thus, as seen in FIG. 2, starting from a virtual representation such as an STL file (11) in a computer of an object to be additively manufactured (or “printed”), and the object is optionally displayed on a build platform on which it will be produced (12). The virtual representation of the object may be a data file (e.g., a polygonal mesh file such as an STL file). However, numerous alternatives to STL files can be used, including but not limited to PLY, OBJ, 3MF, AMF, VRML, X3G, and FBX files, and others as set forth in Barnes et al., US Patent Application Pub. No. 20190026406 (Jan. 24, 2019) and Mummidi et al., US Patent Application Pub. No. 20180113437 (Apr. 26, 2018).

An operator may select (in any sequence) a type or style of surface texture to be applied (13), and a surface to which the texture is to be applied (14) (i.e., all of the object, or a selected portion of the object. In some embodiments, selecting a texture may include selecting a specific texture from a set of available textures for application to the selected surface. A modified virtual representation (again such as an STL file) is then generated, which file is then converted into a primary set of exposure patterns or “slices” (21) by any of a variety of slicer programs (16). The primary set of exposure patterns (21) and the selected surface (14) may be both input into a texturing tool (22), which may generate a modified set of exposure patterns (23) and a corresponding 3D printer control file for said modified set of exposure patterns (24). The 3D object may be printed (25) using the modified set of exposure patterns (23) and the printer control file for the modified set of exposure patterns (24), that is, the 3D object may be additively manufacturing on a 3D printer from a resin using the modified set of exposure patterns and the corresponding 3D printer control file.

Some or all of the members of the primary set of exposure patterns may correspond to portions of the 3D object to which the selected surface texture is to be applied. The modified set of exposure patterns (23) may include a sequential pair of sub-exposure patterns for each member of the primary set of exposure patterns that corresponds to a portion of the 3D object to which the selected surface texture is to be applied. Each sequential pair may include: (i) a first sub-exposure pattern that includes a modified version of the corresponding primary exposure pattern that is modified to include a texture pattern for a surface thereof; and (ii) a second sub-exposure pattern that corresponds to the (unmodified) primary exposure pattern.

The primary set of exposure patterns and/or modified set of exposure patterns each comprise a distinct image file sequence (e.g., a sequence of files in a format such as PNG, GIF, BMP, TIFF, JPEG, etc. See e.g., US Patent Application Pub. No. 2020/0316868 (Oct. 8, 2020) to Jacobson. In some embodiments, the first sub-exposure patterns and second sub-exposure patterns are interleaved with one another within the modified set of exposure patterns.

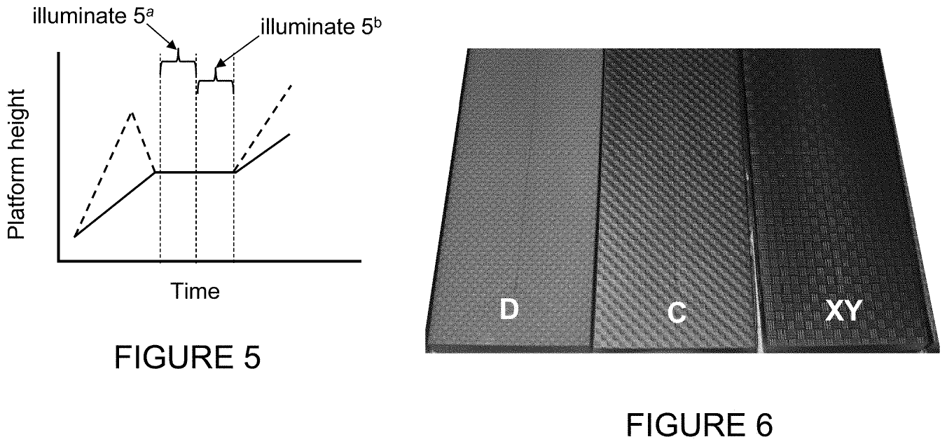

The printer control file for the modified set of exposure patterns (24) may be generated from the primary set of exposure patterns (21) and the selected surface (14). As discussed further with respect to FIG. 5, the corresponding control file configured so that, for each sequential pair of the modified set of exposure patterns, a same segment of light polymerizable resin is sequentially exposed to the first and second sub-exposure patterns for light polymerization, before advancing to a next adjacent segment of resin for light polymerization. The 3D printer control file may be a script (such as a Lua, JavaScript, Perl, Python, C, C++, Tcl, custom programming languages, or C# script). See, e.g., Szabo et al., US Patent Application Pub. No. 2015/0142948).

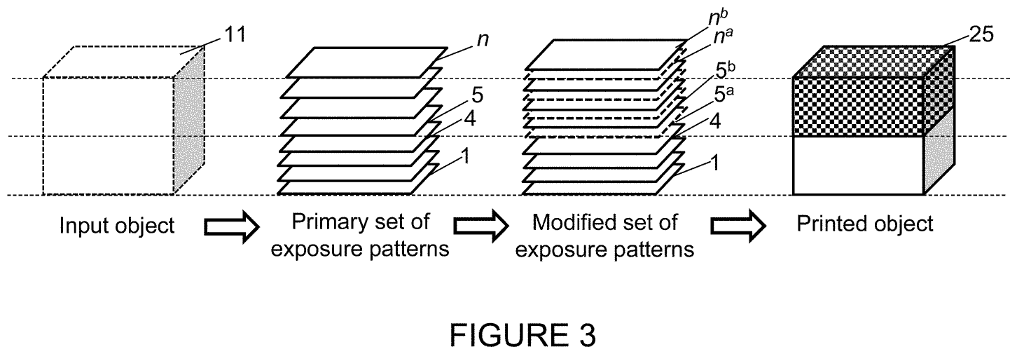

FIG. 3 schematically illustrates a sequence from input of an object as a virtual representation (11). In the example of FIG. 3, an upper portion of the final printed object may be textured while a lower portion of the final printed object may remain untextured, as seen in the right side of FIG. 3. Using the virtual representation of the object, a primary set of exposure patterns is generated that includes slices 1, 2, . . . , n−1, n. In this example, the primary set of exposure patterns may include slices 1-4, which may together correspond to the untextured (lower) portion of the object, and slices 5-n, which may together correspond to the textured (upper) portion of the object. From the primary set of exposure patterns, a modified set of exposure patterns may be generated. In this example, the resultant modified set of exposure patterns may include unmodified exposure patterns 1-4 for the untextured lower portion of the object, and sequential pairs (5^{a}, 5^{b}), . . . (n^{a}, n^{b}) for the textured upper portion of the object. As discussed above, each sequential pair (5^{a}, 5^{b}) . . . (n^{a}, n^{b}) may include a first sub-exposure pattern that includes a modified version of the corresponding primary exposure pattern that is modified to include a texture pattern for a surface thereof (e.g., modified versions of slices 5-n); and a second sub-exposure pattern that corresponds to the (unmodified) primary exposure pattern (e.g., slices 5-n). Using this modified set of exposure patterns, which a printed object can be produced, in accordance with a system and method as described herein.

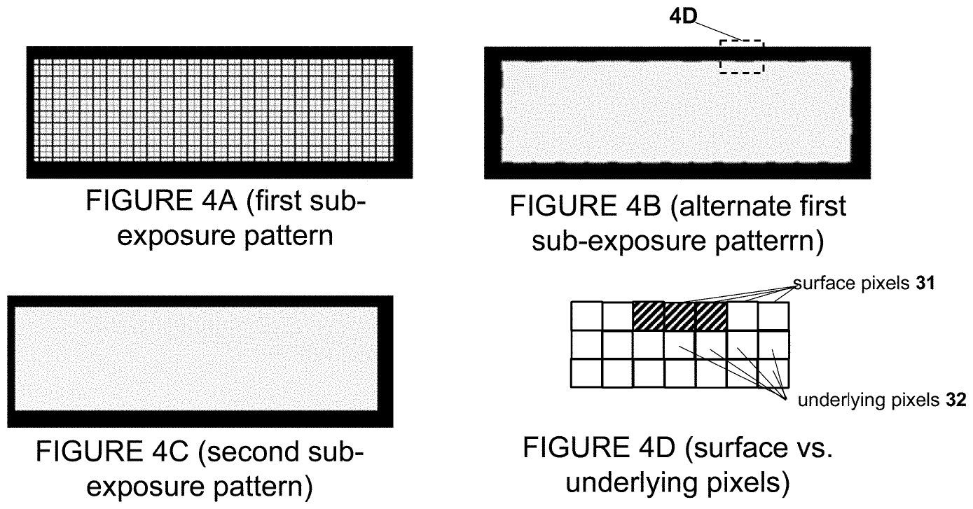

The 3D printer may be a bottom-up or top-down stereolithography apparatus in which a carrier platform on which the 3D object is produced is advanced away from a build plane during production of the object by sequential illumination of the resin. The build plane may be optionally defined by a light transmissive window. The stereolithography apparatus may include a light source for exposing said resin to said modified set of exposure patterns. The light source may include a pixel generator (e.g., a micromirror array, an LCD panel, a diode array, etc.). The surfaces of the 3D object to which a surface texture can be applied may be represented (e.g., represented in the virtual representation of the object) and/or referred to herein as surface pixels. On the other hand, portions of the 3D object that are not textured may be referenced and/or referred to herein as underlying pixels. FIG. 4A schematically illustrates a first sub-exposure pattern, where the surface of the object being produced is completely in-plane with the build platform, and hence every pixel would be a “surface pixel.” Selected surface pixels (e.g., a portion of the surface pixels) may be inactivated or dimmed during this exposure pattern.

FIG. 4B illustrates an alternate first sub-exposure pattern, where surface pixels that are on the sides of the object (e.g., surfaces of the object that neither contact a build platform nor a window) may be patterned. Selected surface pixels (e.g., a portion of the surface pixels) may be inactivated or dimmed during this exposure pattern.

FIG. 4C illustrates a second sub-exposure pattern for either of the first sub-exposure patterns of FIGS. 4A-4B, where all pixels are activated or not dimmed. The exposure pattern of FIG. 4C may correspond to the primary exposure pattern (21 of FIG. 2). Note, in both cases, bulk exposure of the object remains the same.

FIG. 4D schematically illustrates a portion of FIG. 4B (delineated by box 4D therein), and distinguishes surface pixels from underlying pixels. The underlying pixels are shown two rows deep. The cross-hatched boxes represent pixels that are selectively inactivated or dimmed.

Accordingly, FIGS. 4A-4D show that for each sequential pair of the modified set of exposure patterns (23), each second sub-exposure pattern corresponds to a respective member of the primary set of exposure patterns (21), and each first sub-exposure pattern differs from the respective member of the primary set of exposure patterns by the selective patterned dimming or inactivation of said surface pixels. In some embodiments, the selective dimming of surface pixels in said first sub-exposure pattern may be without selective dimming of underlying pixels, or without selective dimming of underlying pixels beyond a depth greater than 1, 2 or 3 underlying pixels.

As an example, when the light source includes micromirrors, LCD panel, diode array, or the like, the individual surface pixels may be turned on or off for the duration of the exposure (selectively activated or inactivated). Intermediate brightness or dimming can be achieved by pulse width modulation or by using a duty cycle. Brighter pixels may result from a longer bright operation, while darker or dimmer pixels may result from a shorter bright operation. In other words, a dimmed pixel may be produced by setting a micromirror “on” for part of the exposure time and “off” for the remaining time. Selective dimming of said surface pixels may include controlling the light source or pixel generator to increase an off time period in a duty cycle in which the surface pixels (that is, the micromirrors or components that irradiate the surface pixels) are turned off. For example, in some embodiments, selective dimming of a surface pixel may be obtained by turning a pixel off for e.g., 10, 20, 50, 90, or 100% of the duration of an exposure. In some embodiments, selective dimming of the surface pixels may be obtained by applying a lower voltage to components of the light source that irradiate the surface pixels.

FIG. 5 is a graph schematically illustrating platform movement over time, and exposure over time, for a portion of a method as described in FIG. 3 herein, as it can be implemented in a bottom-up stereolithography apparatus. In some embodiments, the bottom-up stereolithography apparatus may operate in one or more different modes, such as a stepped mode or a reciprocal or “pumped” mode as described in, for example, U.S. Pat. No. 10,471,699 to Ermoshkin et al. The solid line indicates the apparatus is operating in stepped mode, and the dashed line indicates the apparatus is operating in reciprocal (or “pumped”) mode. In both the stepped mode or the reciprocal mode, the resin may be sequentially illuminated by patterns 5^{a} and 5^{b} while the platform is stationary. Hence the same segment of resin is being exposed by both patterns.

Accordingly, as discussed above, a 3D printer control file (23 from FIG. 2) may be generated for the modified set of exposure patterns (24 from FIG. 2). The 3D printer control file generated for the modified set of exposure patterns may be configured so that, for each member of the modified set of exposure patterns that corresponds to a portion of the object to which the selected surface texture is to be applied, a same segment of light polymerizable resin is sequentially exposed to the first and second sub-exposure patterns for light polymerization, before advancing to a next adjacent segment of resin for light polymerization. In other words, the control file (23) may be configured so that the carrier platform is stationary during exposure of a same segment of the resin to each sequential pair of first and second sub-exposure patterns.

In some embodiments, the time for which each resin segment is exposed to a first sub-exposure pattern, can be adjusted as desired (for example, from 10 or 20 percent, to 50, 60, 70, or 90 percent, of the total time each resin segment is exposed to the sum of the first and second sub-exposure patterns). In some embodiments, there is no gap in time between the illumination of each resin segment with by the first and second sub-exposure patterns, though in other embodiments a small gap in time (e.g., up to 50 or 100 milliseconds, or more) can be interposed between the two sequential sub-exposure patterns.

The control file (e.g., LUA script) may correspond with the modified set of exposure patterns, so that the printer will properly behave in the region to be textured. In a preferred embodiment, that the control file may be generated using the primary set of exposure patterns (21 from FIG. 2) and the selected texture (14 from FIG. 2). Stated differently, in some embodiments the control file may not be generated “from” the sub-exposure patterns, but may instead be generated to “correspond/work properly” with the sub-exposure patterns. This may be because the control file does not need to “know” what the texture is (e.g., checker, diamond, etc.), but does need to know the indices of the exposure patterns in the modified stack of exposure patterns (which may be a PNG stack) that will act as the first sub-exposure and the second sub-exposures. By using the indices of these sub-exposure patterns, the control file may be able to adjust the movement/exposure times appropriately. This range of indices in the modified control file can be derived based on the selected surface.

While the process is described herein with two sub-exposure patterns, additional sub-exposure patterns can be included if desired.

FIG. 6 shows three sample objects additively manufactured from a dual cure resin (Carbon. Inc. RPU70), following washing and further curing, as textured during additive manufacturing with a diamond (D), checker (C), or XY grid strip (XY) or “basket weave” texture pattern. The present disclosure is not limited to the texture patterns shown in FIG. 6, and may be used with various geometric patterns without exception. For example, the geometric pattern may include repeating grids, curves (e.g., elliptical curves, circles, or the like), spirals, pinwheels, parallelograms, or the like. Additional non-limiting illustrative examples of textures may be found in “Survey of Procedural Methods for Two-Dimensional Texture Generation” by Dong et al. (Sensors 2020; 20(4):1135. https://doi.org/10.3390/s20041135).

According to some embodiments, surface texturing of a three-dimensional (3D) object during additive manufacturing of the object from a polymerizable resin on a 3D printer, the 3D object having a shape defined by a primary set of exposure patterns may include irradiating a resin segment with patterned light at a build plane while the resin segment is contacting the growing 3D object to polymerize the resin and further grow the 3D object, then advancing the object away from the build plane to bring a new segment of the resin in contact with the growing 3D object and establish a new build plane. The irradiating and advancing steps are performed until the 3D object is formed. For resin segments corresponding to portions of the 3D object to which surface texture is applied, the irradiating step is carried out by sequentially irradiating each resin segment with a first sub-exposure pattern comprising a member of the primary set of exposure patterns modified to include a texture pattern for a surface thereof; and a second sub-exposure pattern corresponding to said member of the primary set of exposure patterns.

The first sub-exposure pattern may differ from said second sub-exposure pattern by the selective patterned dimming of said surface pixels. Selective dimming of surface pixels in said first sub-exposure pattern may be without selective dimming of underlying pixels, or without selective dimming of underlying pixels beyond a depth greater than 1, 2 or 3 underlying pixels. Selective dimming of the surface pixels may include increasing an off time period in a duty cycle in which said surface pixels are turned off.

The 3D printer may be a bottom-up or top-down stereolithography apparatus in which a carrier platform on which the 3D object is produced is advanced away from a build plane during production of said object by sequential illumination of the resin from a light source. The build plane may be defined by a light transmissive window. The carrier platform and the light source may be operated by a 3D printer control file that is configured so that a same segment of light polymerizable resin is sequentially exposed to the first and second sub-exposure patterns for light polymerization, before advancing to a next adjacent segment of resin for light polymerization. The control file may be configured so that the carrier platform is stationary during exposure of a same segment of the resin to each sequential pair of first and second sub-exposure patterns. The apparatus may include a light source for exposing said resin to said set of modified exposure patterns, said light source comprising a pixel generator (e.g., a micromirror array, an LCD panel, a diode array, etc.)

In some embodiments, the resin is a dual cure resin, and manufacturing the 3D object may include cleaning said 3D object (e.g., by washing, wiping, blowing, centrifugal separation, or a combination thereof), and then further curing said 3D object (e.g., by baking, microwave irradiating, contacting to water, catalyst-initiated polymerization, etc., including combinations thereof). The resin may include a mixture of (i) a light polymerizable liquid first component, and (ii) a second solidifiable component that is different from said first component.

The 3D object may be a polymer blend, interpenetrating polymer network, semi-interpenetrating polymer network, or sequential interpenetrating polymer network formed from said first component and said second component. The 3D object may be comprised of polyurethane, polyurea, silicone, epoxy, cyanate ester, or a combination thereof. The 3D object may be rigid, flexible, or elastic.

The foregoing is illustrative of the present invention, and is not to be construed as limiting thereof. The invention is defined by the following claims, with equivalents of the claims to be included therein.

We claim:

1. A method of surface texturing a three-dimensional (3D) object during additive manufacturing of the object from a polymerizable resin on a 3D printer, the 3D object having a shape defined by a primary set of exposure patterns, the method comprising the steps of:
(a) irradiating a resin segment with patterned light at a build plane while said segment is contacting said growing 3D object to polymerize said resin and further grow said 3D object, then
(b) advancing said object away from said build plane to bring a new segment of said resin in contact with said growing 3D object and establish a new build plane, and then
(c) repeating steps (a) through (b) until said 3D object is formed,
wherein, for those resin segments corresponding to portions of said 3D object to which surface texture is applied, said irradiating step is carried out by sequentially irradiating each resin segment with:
(i) a first sub-exposure pattern comprising a member of the primary set of exposure patterns modified to include a texture pattern for a surface thereof; and
(ii) a second sub-exposure pattern corresponding to said member of the primary set of exposure patterns.

2. The method of claim 1, wherein: said first sub-exposure pattern differs from said second sub-exposure pattern by selective patterned dimming of surface pixels in said first sub-exposure pattern.

3. The method of claim 2, wherein said selective patterned dimming of surface pixels in said first sub-exposure pattern is:
(i) without selective dimming of underlying pixels, or
(ii) without selective dimming of underlying pixels beyond a depth greater than 1, 2 or 3 underlying pixels.

4. The method of claim 2, wherein said selective patterned dimming of said surface pixels in said first sub-exposure pattern comprises increasing an off time period in a duty cycle in which said surface pixels are turned off.

5. The method of claim 1, wherein said 3D printer comprises a bottom-up or top-down stereolithography apparatus in which a carrier platform on which said 3D object is produced is advanced away from a build plane (the build plane optionally defined by a light transmissive window) during production of said object by sequential illumination of said resin from a light source, and
said carrier platform and said light source are operated by a 3D printer control file, said control file configured so that a same segment of light polymerizable resin is sequentially exposed to the first and second sub-exposure patterns for light polymerization, before advancing to a next adjacent segment of resin for light polymerization.

6. The method of claim 5, wherein said control file is configured so that said carrier platform is stationary during exposure of a same segment of said resin to each sequential pair of first and second sub-exposure patterns.

7. The method of claim 5, wherein said apparatus comprises a light source for exposing said resin to said set of modified exposure patterns, said light source comprising a pixel generator (e.g., a micromirror array, an LCD panel, a diode array, etc.).

8. The method of claim 1, wherein said resin is a dual cure resin, and said method further comprises the steps of:
(d) cleaning said 3D object (e.g., by washing, wiping, blowing, centrifugal separation, or a combination thereof), and then
(e) further curing said 3D object (e.g., by baking, microwave irradiating, contacting to water, catalyst-initiated polymerization, etc., including combinations thereof).

9. The method of claim 1, wherein said resin comprises a mixture of (i) a light polymerizable liquid first component, and (ii) a second solidifiable component that is different from said first component.

10. The method of claim 9, wherein said 3D object comprises a polymer blend, interpenetrating polymer network, semi-interpenetrating polymer network, or sequential interpenetrating polymer network formed from said first component and said second component.

11. The method of claim 1, wherein:
said 3D object is comprised of polyurethane, polyurea, silicone, epoxy, cyanate ester, or a combination thereof; and/or
said 3D object is rigid, flexible, or elastic.

12. A computer-implemented method of applying a surface texture to a surface of a three-dimensional (3D) object for additive manufacturing thereof from a resin on a 3D printer in which adjacent segments of the resin are sequentially light polymerized to form the 3D object, the method comprising the steps of:
(a) selecting a surface of an object to be textured with a texture pattern;
(b) slicing the object into a primary set of exposure patterns, each member of the set corresponding to a segment of the 3D object to be additively manufactured;
(c) generating, from the primary set of exposure patterns and the selected surface, a modified set of exposure patterns, the modified set of exposure patterns including a sequential pair of sub-exposure patterns for each member of the primary set of exposure patterns corresponding to a portion of the 3D object to which surface texture is to be applied, each sequential pair comprising:
(i) a first sub-exposure pattern comprising said member of the primary set of exposure patterns modified to include a texture pattern for a surface thereof; and
(ii) a second sub-exposure pattern corresponding to said member of the primary set of exposure patterns; and
(d) generating, from said primary set of exposure patterns and said selected surface, a corresponding 3D printer control file for said modified set of exposure patterns, said corresponding control file configured so that, for each sequential pair of sub-exposure patterns of the modified set of exposure patterns, a segment of light polymerizable resin is sequentially exposed to both the first and second sub-exposure patterns for light polymerization before advancing to a next adjacent segment of resin for light polymerization.

13. The method of claim 12, wherein:
a first member of the primary set of exposure patterns includes surface pixels;
a first one of the second sub-exposure patterns corresponds to said first member, and
a first one of the first sub-exposure patterns differs from said first one of the second sub-exposure patterns by the selective patterned dimming of said surface pixels.

14. The method of claim 13, wherein said selective dimming of surface pixels in said first sub-exposure pattern is:
(i) without selective dimming of underlying pixels, or
(ii) without selective dimming of underlying pixels beyond a depth greater than 1, 2 or 3 underlying pixels.

15. The method of claim 12, wherein said object comprises a data file (e.g., a polygonal mesh file such as an STL file).

16. The method of claim 12, wherein said modified set of exposure patterns comprises first sub-exposure patterns and second sub-exposure patterns interleaved with one another.

17. The method of claim 12, wherein said selecting step (a) further comprises selecting a specific texture from a set of available textures for application to said selected surface.

18. The method of claim 12, further comprising additively manufacturing said object on a 3D printer from a resin with said modified set of exposure patterns and said corresponding 3D printer control file.

19. The method of claim 18, wherein said 3D printer comprises a bottom-up or top-down stereolithography apparatus in which a carrier platform on which said 3D object is produced is advanced away from a build plane (the build plane optionally defined by a light transmissive window) during production of said object by sequential illumination of said resin, and wherein said control file is configured so that said carrier platform is stationary during exposure of a same segment of said resin to each sequential pair of first and second sub-exposure patterns.

20. The method of claim 19, wherein said stereolithography apparatus comprises a light source for exposing said resin to said modified set of exposure patterns, said light source comprising a pixel generator (e.g., a micromirror array, an LCD panel, a diode array, etc.).
